(19) United States
(12) Patent Application Publication
(10) Pub. No.: US 2012/0320566 A1
(43) Pub. Date: Dec. 20, 2012

(54) LIQUID CRYSTAL DISPLAY DEVICE, AND LED BACKLIGHT UNIT

(75) Inventor: Yuuki Namekata, Osaka-shi (JP)

(73) Assignee: SHARP KABUSHIKI KAISHA, Osaka-shi, Osaka (JP)

(21) Appl. No.: 13/579,098

(22) PCT Filed: Nov. 16, 2010
(86) PCT No.: PCT/JP2010/070349

§ 371 Date: Aug. 15, 2012

(30) Foreign Application Priority Data
Feb. 25, 2010 (JP) 2010-039681

(51) Int. Cl. G02F 1/13357; F21V 29/02

(52) U.S. Cl. 362/97.3

(57) ABSTRACT

Provided is a liquid crystal display device and a backlight unit that are of high quality and have a simple configuration that a mechanism cooling a cooling medium is not included. Included are a liquid crystal display panel and an LED backlight unit including an LED light source emitting light toward the panel, and a chassis plate on which the light source is disposed, the plate including a through flow path for cooling air dissipating heat from the light source, wherein the path includes a main duct introducing the cooling air and disposed along one side of the panel, and a branch duct branching off from the main duct, aligned along a disposed direction of the light source, and including an exhaust port disposed at an end of the branch duct and discharging the cooling air to outside of the device.

### TECHNICAL FIELD

The present invention relates to an LED backlight unit including LEDs that define a light source, and having a configuration of dissipating heat that is generated by emission of light from the LED light source, and relates to a liquid crystal display device including the LED backlight unit of this kind.

### BACKGROUND ART

A liquid crystal display device including a transmissive liquid crystal display panel includes a backlight unit arranged to project light onto the liquid crystal display panel. The backlight unit of this kind generally includes a light source, and an optical member such as a diffusion sheet that is arranged to uniform brightness distribution of the light emitted from the light source.

Recently, compact fluorescent tubes that are referred to as cold cathode fluorescent lights (CCFLs) are often used as a light source in a liquid crystal display device. However, the cold cathode fluorescent lights contain mercury that is a harmful material in their discharge tubes, so that there arises an environmental problem such as a problem of disposal of the used tubes. In addition, a high-frequency power source is required of the liquid crystal display device, so that a constituent element for noise suppression is also required of the liquid crystal display device.

The liquid crystal display device including the cold cathode fluorescent lights (CCFL) is replaced with a liquid crystal display device including LEDs (Light Emitting Diodes) as a light source of a backlight unit, which are free from the defects the cold cathode fluorescent lights have. Using the LED light source does not present the above-described problems of the harmful material (mercury) and the noise suppression. In addition, using the LED light source contributes greatly to low power consumption, and weight reduction of the device. For this reason, as the LED technology progresses (e.g., as the price of the LEDs is reduced, as luminous efficiency of the LEDs improves), the LED backlight unit including the LEDs as the light source has been in widespread use as a backlight for a liquid crystal display device in these years.

However, because LED tips of the LED light source generate heat, the LED light source has a problem of reduction in luminous efficiency and reduction in longevity of the LEDs. To be specific, as the temperature at PN junctions of the diodes (generally referred to as a junction temperature) rises, the luminous efficiency and the longevity of the LEDs are reduced. For example, if the amounts of the current to the LEDs are increased to increase the brightness of each LED, the heating values from the LEDs rise, which reduces the luminous efficiency and the longevity of the LEDs.

In order to solve these problems, an LED backlight unit (liquid crystal display device) including a cooling mechanism arranged to cool an LED light source is known as disclosed in PTLs 1 and 2. PTL 1 discloses a liquid crystal display device including a cooling mechanism, in which a pipe that forms a predetermined cycling pathway is provided on a back surface of an LED light source, through which a cooling fluid passes to cool the heat-generating LED light source. In PTL 1, the cycling pathway of the cooling fluid runs in a zigzag vertically and horizontally corresponding to the shape of a panel, or runs in a spiral fashion corresponding to the shape of the panel.

PTL 2 discloses a liquid crystal display device including a cooling mechanism, in which a plurality of heat pipes are provided to an LED backlight unit to cool an LED light source. To be specific, when the LED light source emits light to generate heat, a hydraulic fluid in the heat pipes evaporates to absorb the heat. The evaporated hydraulic fluid moves to low-temperature portions at both the ends of each heat pipe (at positions outside of a liquid crystal panel), which define radiating fins, for example, and then condenses there. The condensed hydraulic fluid returns to the inside of the liquid crystal display panel due to a capillary phenomenon, and is used again to absorb heat generated by the emission of light from the LED light source.

### Citation List

### Patent Literature

PTL 1: JP2007-200869

PTL 2: JP2009-64706

### SUMMARY OF INVENTION

### Technical Problem

However, problems arise in the configurations disclosed in PTLs 1 and 2. In the configuration disclosed in PTL 1, the cooling fluid (cooling medium) “circulates” through the pipe. Thus, the cooling fluid (cooling medium), which contributes to the cooling of the heating LED light source and rises in temperature, needs to be cooled. To be specific, it is necessary to separately provide a cooling-medium cooling mechanism, which is arranged to cool the cooling fluid, such as a cooler arranged to cool the cooling fluid and disposed inside or outside of the liquid crystal display device, or such as a pathway for natural cooling disposed outside of the liquid crystal display device. However, providing the cooling-medium cooling mechanism seriously hinders thin profile, weight reduction and price reduction of the liquid crystal display device.

In addition, there arises another problem that the cooling effect of the cooling fluid could decrease drastically due to a secular deterioration of the cooling fluid. If the cooling effect decreases, the longevity of the LEDs is reduced, so that the effect to use the LED light source that has a longer life than a cold cathode fluorescent light diminishes.

In addition, there arises other problems that the cooling fluid could leak out of a joint between a pipe and a pump or between pipes, and that condensation could occur inside the device, which causes a defect in product quality of the liquid crystal display device that defines an electrical appliance.

Meanwhile, in the configuration disclosed in PTL 2, the heat pipes for cooling runs in a complicated fashion (wicks are required depending on circumstances), which causes a problem of increase in cost. In addition, the radiating member (cooling-medium cooling mechanism) arranged to make the evaporated hydraulic fluid (cooling medium) condense needs to be provided outside of the liquid crystal display device, which causes a problem of increase in size of the liquid crystal display device.

The present invention is made in view of the problems described above, and an object of the present invention is to provide a liquid crystal display device and an LED backlight unit, which have a configuration capable of preventing an increase in temperature due to emission of light from an LED light source. To be more specific, the object of the present invention is to provide a liquid crystal display device and an LED backlight unit that are of high quality and have a simple configuration that a cooling-medium cooling mechanism, which is arranged to cool a cooling medium that contributes to cooling, is not included.

### SOLUTION TO PROBLEM

To achieve the objects and in accordance with the purpose of the present invention, a liquid crystal display device of a preferred embodiment of the present invention includes a liquid crystal display panel and an LED backlight unit disposed behind the liquid crystal display panel, the backlight unit including an LED light source arranged to emit LED light toward the liquid crystal display panel and a chassis plate on which the LED light source is disposed, the chassis plate including a through flow path for cooling air that is arranged to dissipate heat generated by the emission of light from the LED light source, wherein the through flow path includes a main duct arranged to introduce the cooling air, the main duct being disposed along one side of the liquid crystal display panel, and a branch duct that branches off from the main duct, is aligned along a disposed direction of the LED light source, and includes an exhaust port that is disposed at an end of the branch duct and arranged to discharge the cooling air to outside of the device.

In addition, a backlight unit of a preferred embodiment of the present invention defines an LED backlight unit that is used behind a display screen such as a liquid crystal display panel, and includes an LED light source arranged to emit LED light toward the liquid crystal display panel and a chassis plate on which the LED light source is disposed, the chassis plate including a through flow path for cooling air that is arranged to dissipate heat generated by the emission of light from the LED light source, wherein the through flow path includes a main duct arranged to introduce the cooling air, the main duct being disposed along one side of the liquid crystal display panel, and a branch duct that branches off from the main duct, is aligned along a disposed direction of the LED light source, and includes an exhaust port that is disposed at an end of the branch duct and arranged to discharge the cooling air to outside of the device.

It is preferable that the LED light source is disposed over an entire surface of the chassis plate, the surface being opposed to the liquid crystal display panel, and the branch duct includes a plurality of branch ducts that are aligned along the disposed direction of the LED light source on a back surface of the chassis plate.

It is preferable that the LED light source includes a plurality of LED light sources that are disposed on inner surfaces of the chassis plate, the inner surfaces being opposed to each other, and the main duct and the branch duct are aligned along disposed directions of the LED light sources on a back surface of the chassis plate.

It is preferable that when the branch duct includes the plurality of branch ducts, each flow passage of the plurality of branch ducts has a rectangular shape in cross section, has a round shape in cross section, or has a triangular shape in cross section and the flow passages face and fit each other.

It is preferable that the liquid crystal display panel stands, the main duct of the through flow path is disposed in a lateral direction along a lower end of the chassis plate, and the branch duct is disposed in a longitudinal direction along the chassis plate, whereby the cooling air flows upward.

It is preferable that the exhaust port disposed at the end of the branch duct is open toward a back surface of the device.

It is preferable that the through flow path and the chassis plate are of separate construction. Alternatively, it is preferable that the through flow path and the chassis plate are of monolithic construction.

It is preferable that the through flow path is made from either one of copper and a copper alloy, or either one of aluminum and an aluminum alloy.

It is preferable that a base portion of the main duct is connected to an air blower that is arranged to force the air to be introduced into the main duct.

It is preferable that the through flow path further includes a divider arranged to divide the through flow path along a direction that the cooling air flows.

### ADVANTAGEOUS EFFECTS OF INVENTION

The configuration of the liquid crystal display device and the LED backlight unit of the preferred embodiments of the present invention that the cooling air that defines a cooling medium runs through the through flow path including the main duct arranged to introduce the cooling air and the branch duct aligned along the disposed direction of the LED light source allows the heat generated by the emission of light from the LED light source to be cooled efficiently. In addition, the configuration that the branch duct includes the exhaust port disposed at the end of the branch duct allows the air used for cooling to be discharged to the outside of the device. In other words, the cooling air that has risen in temperature can be discharged to the outside to introduce new cooling air (low in temperature) in turn into the main duct. Thus, it is unnecessary to provide a cooling-medium cooling mechanism such as a cooler arranged to cool the cooling air that has risen in temperature.

When the LED light source is the “direct” backlight having the configuration that the LED light source is disposed over the entire surface of the chassis plate that is opposed to the liquid crystal display panel, the branch ducts are aligned along the LED light source on the entire surface. Meanwhile, when the LED light source is the “side” backlight having the configuration that the LED light sources are disposed on the opposed inner surfaces of the chassis plate, the main duct and the branch duct are aligned along the inner surfaces. These configurations of the through flow path disposed in accordance with the disposition of the light source(s) allow the LED light source(s) to be cooled efficiently.

The configuration that each flow passage of the plurality of branch ducts has the rectangular shape in cross section can prevent the branch ducts from increasing in thickness while allowing a flow rate of the cooling air for cooling the LED light source to be increased (allowing a large cross-sectional area to be obtained). The configuration that each flow passage of the plurality of branch ducts has the round shape in cross section allows the flow passages to be easily formed. The configuration that each flow passage of the plurality of branch ducts has the triangular shape in cross section and the follow passages face and fit each other can prevent the branch ducts from increasing in thickness while allowing a flow rate of the cooling air for cooling the LED light source to be increased (allowing a large cross-sectional area to be obtained).

The configuration that the cooling air flows upward allows the air (air used for cooling) that has been heated by the light source to be discharged smoothly to the outside of the device.

The configuration that the exhaust port disposed at the end of the branch duct is open toward the back surface of the device can reduce an adverse effect caused by the discharge air used for cooling. To be specific, because the liquid crystal display device is usually installed such that its back surface is opposed to a wall of a house, the configuration that the air is discharged from the back surface of the device improve the usability of the display device.

The configuration that the through flow path and the chassis plate are of separate construction allows the through flow path to be easily formed. Meanwhile, the configuration that the through flow path and the chassis plate are of monolithic construction can improve the cooling effect of the LED light source because the cooling air runs closer to the LED light source.

The configuration that the through flow path is made from the copper or the copper alloy or the aluminum or the aluminum alloy that have excellent thermal conductivity can improve the cooling effect of the LED light source.

The configuration of including the air blower arranged to force the air to be introduced into the main duct allows the cooling air that is low in temperature to be smoothly introduced into the through flow path, which can further improve the cooling effect.

The configuration of including the divider arranged to divide the through flow path along the direction that the cooling air flows can increase the surface area inside the flow passage through which the cooling air runs, which can improve the cooling effect of the LED light source by the cooling air.

### BRIEF DESCRIPTION OF DRAWINGS

FIG. 1 is an exploded perspective view showing a liquid crystal display device of a first embodiment of the present invention.

FIG. 2 is an enlarged cross-sectional view showing the liquid crystal display device shown in FIG. 1.

FIG. 3 is a schematic view showing a cooling device (a through flow path) of the liquid crystal display device shown in FIG. 1.

FIG. 4 is a schematic view showing a cooling device (a through flow path) of a liquid crystal display device of a second embodiment of the present invention.

FIG. 5 is a schematic view showing a cooling device (a through flow path) of a liquid crystal display device of a third embodiment of the present invention.

FIG. 6 is a schematic view showing a cooling device (a through flow path) of a liquid crystal display device of a fourth embodiment of the present invention.

FIG. 7 is a schematic view showing a cooling device (a through flow path) of a liquid crystal display device of a fifth embodiment of the present invention.

FIG. 8 is an exploded perspective view showing a liquid crystal display device of a sixth embodiment of the present invention.

FIG. 9 is a schematic view showing a cooling device (a through flow path) of the liquid crystal display device shown in FIG. 8.

FIG. 10 is a schematic view showing a cooling device (a through flow path) of a liquid crystal display device (a direct backlight) of a seventh embodiment of the present invention.

FIG. 11 is a schematic view showing a cooling device (a through flow path) of a liquid crystal display device (a side backlight) of the seventh embodiment of the present invention.

FIG. 12 is a schematic cross-sectional view showing a through flow path of a first modified example.

FIG. 13 is a schematic cross-sectional view showing a through flow path of a second modified example.

FIG. 14 is a schematic cross-sectional view showing a through flow path of a third modified example.

### DESCRIPTION OF EMBODIMENTS

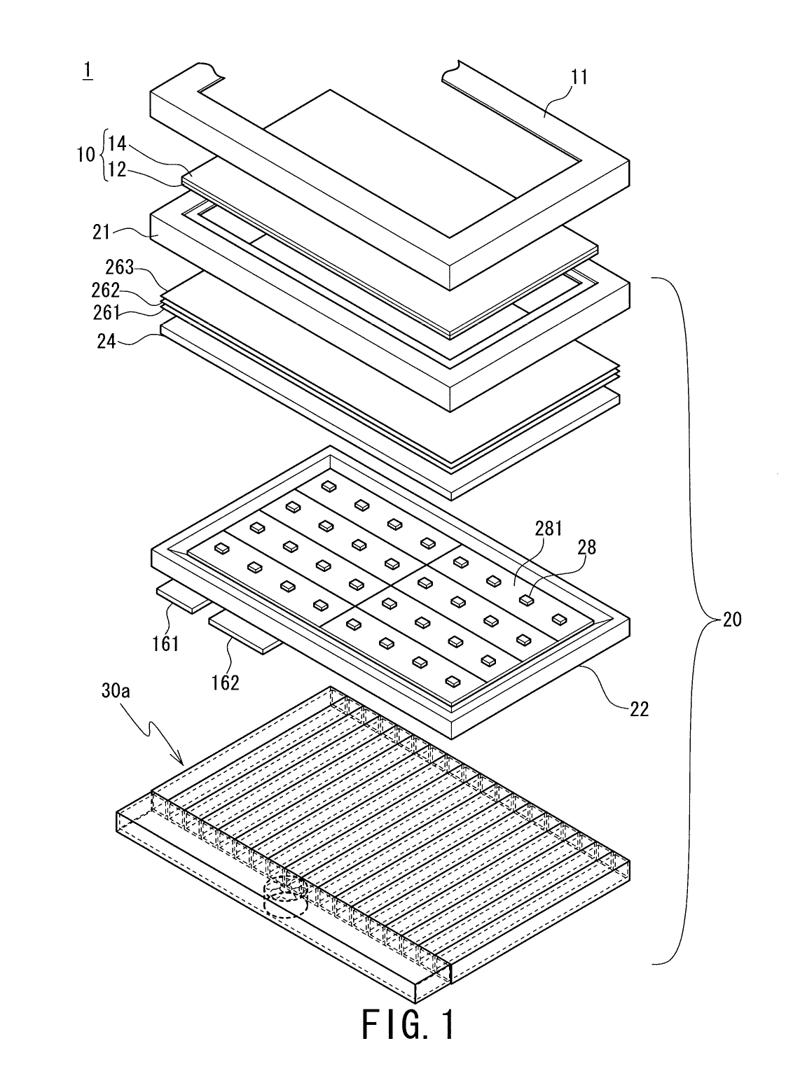

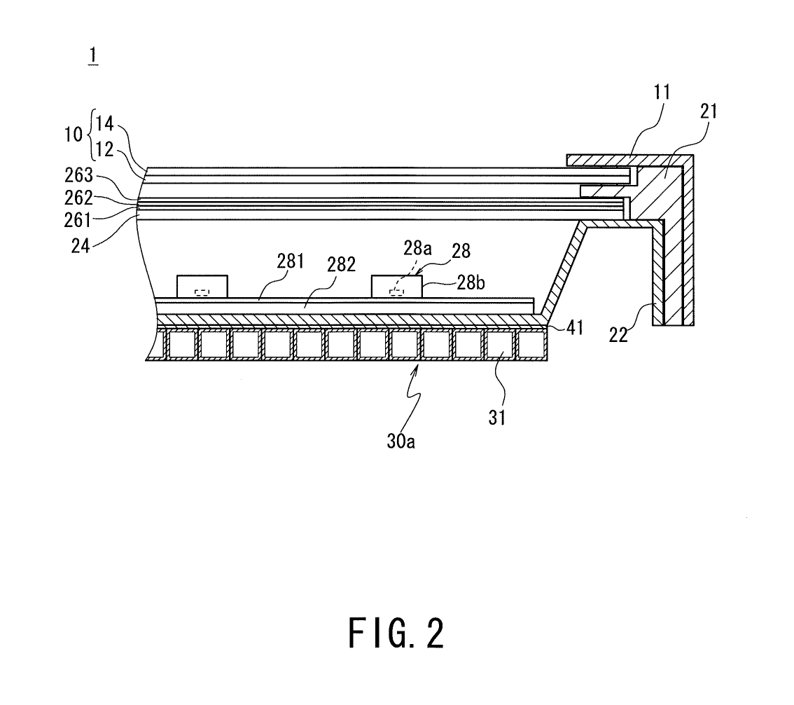

A detailed description of preferred embodiments of the present invention will now be provided with reference to the accompanying drawings. First, the first embodiment will be described. FIG. 1 is an exploded perspective view showing a liquid crystal display device 1 of the first embodiment of the present invention. FIG. 2 is an enlarged cross-sectional view showing the liquid crystal display device 1. It is to be noted that an up/down direction in the following description means the up/down direction in FIGS. 1 and 2.

The liquid crystal display device 1 of the present embodiment includes a liquid crystal display panel 10 and an LED backlight unit 20. The liquid crystal display panel 10 includes a thin film transistor (TFT) array substrate 12 (hereinafter, referred to simply as an array substrate 12) , and a color filter (CF) substrate 14, and is fixed by a bezel 11 having a frame shape. The array substrate 12 and the color filter substrate 14 are opposed to each other having a given cell gap therebetween, in which liquid crystals are filled.

The array substrate 12 defines a glass substrate on which TFTs and pixel electrodes are arranged in a matrix. The color filter substrate 14 defines a glass substrate same in size as the array substrate 12, on which a plurality of color filters are arranged in a matrix, and over the entire surface of which a transparent common electrode is formed. By varying a voltage applied to the pixel electrodes and the common electrode, alignment of the liquid crystals filled between the substrates is controlled.

The LED backlight unit 20 (the LED backlight unit of the first embodiment) defines an illuminating device that is used disposed behind the liquid crystal display panel 10. The LED backlight unit 20 of the present embodiment defines a so-called “direct” LED backlight unit having a configuration such that LED light sources 28 are disposed over the entire surface of the LED backlight unit 20, the surface being opposed to the liquid crystal display panel 10.

The LED backlight unit 20 includes a frame 21, a chassis plate 22, a diffusion plate 24, optical sheets 261, 262 and 263, the LED light sources 28, and a cooling device 30a as shown in FIGS. 1 and 2.

The frame 21 has a square frame shape, where sides which form the frame have the shape of the letter “L” in cross section. The frame 21 is arranged to fix the diffusion plate 24 and the optical sheets 261, 262 and 263 that are stacked on the chassis plate 22. To be specific, edge portions of the diffusion plate 24 and the optical sheets 261, 262 and 263 are sandwiched between the frame 21 and the chassis plate 22 as shown in FIG. 2.

The chassis plate 22 is made from aluminum or an aluminum alloy, and has the shape of a box of low height. The LED light sources 28 are disposed on an inner bottom surface of the chassis plate 22. The chassis plate 22 includes an outer edge portion having a horizontal surface, on which the diffusion plate 24 and the optical sheets 261, 262 and 263 are placed. The diffusion plate 24 and the optical sheets 261, 262 and 263 are fixed so as not to move by the frame 21 that is fixed from above of the chassis 22 (sandwiched between the frame 21 and the chassis plate 22).

The diffusion plate 24 has a rectangular plate shape when seen in a plan view (about 2 to 3 mm in thickness), and is preferably made from a resin. The diffusion plate 24 is arranged to diffuse light emitted from the LED light sources 28 so as to be uniform. In other words, the diffusion plate 24, together with a diffusion sheet 26 to be described later, is arranged to uniformalize brightness distribution in a plane direction of the light that reaches the liquid crystal display panel 10.

The optical sheets 261, 262 and 263 have a rectangular sheet shape when seen in a plan view, and are preferably made from a resin. The optical sheets 261, 262 and 263 can be combined appropriately depending on the properties that are required of the liquid crystal display device 1. For example, combination of the diffusion sheet 261, the lens sheet 262 and the reflection sheet 263 is used, which are stacked in this order from the bottom. The diffusion sheet 261 is arranged to further diffuse the light randomly that is diffused by the diffusion plate 26, allowing further uniformalization of the brightness distribution in the plane direction of the light that reaches the liquid crystal display panel 10. The lens sheet 262 is arranged to condense the light that passes through the diffusion sheet 261, allowing enhancement of brightness of the light. The reflection sheet 263 is arranged to transmit polarized light in a given direction (light that is polarized in a given direction) and reflect polarized light other than the polarized light in the given direction so that the light that reaches the liquid crystal display panel 10 is not absorbed by a polarizing plate that is attached on a light-receiving surface (under surface) of the liquid crystal display panel 10.

The LED light sources 28 are disposed on the inner bottom surface (plate surface) of the chassis plate 22. To be specific, a plurality of LED substrates 281 (two x four=eight substrates in the present embodiment) are disposed on the inner bottom surface of the chassis plate 22. The plurality of LED light sources 28 (LED chips 28a)(four LED light sources in the present embodiment) are disposed linearly in a longitudinal direction of each LED substrate 281. Thus, the LED light sources 28 (four x eight=thirty-two LED light sources in the present embodiment) are arranged in a matrix on the inner bottom surface of the chassis plate 22 as shown in FIG. 1.

The LED light sources 28 define so-called white LEDs that emit white light. A variety of white LEDs are known, and the white LEDs used in the present embodiment are not limited specifically. For example, white LEDs include LED chips 28a that emit blue light and are encapsulated in transparent resins 28b into which yellow fluorescent materials are mixed as shown in FIG. 2.

Wiring patterns (not shown) arranged to supply power to the disposed LED light sources 28 are provided on the LED substrates 281. The wiring patterns provided on the LED substrates 281 are electrically connected to a power board 161 for LEDs that is disposed on a back surface of the chassis plate 22. The power board 16 includes an LED control unit consisting of IC chips and other constituent elements. The LED control unit is arranged to control on/off driving of the LED light sources 28. A control board 162 that is arranged to control the liquid crystal display panel 10 (TFTs) is disposed next to the power board 161 for LEDs on the back surface of the chassis plate 22.

A radiating plate 282 is sandwiched between the LED substrates 281 and the inner bottom surface of the chassis plate 22. The radiating plate 282 is in close contact with the inner bottom surface of the chassis plate 22. The radiating plate 282 is arranged to prevent an increase in temperature due to emission of the light from the LED light sources 28. In other words, the radiating plate 282 is arranged to smoothly convey the heat emitted from the LED light sources 28 to the chassis plate 22 so that the heat does not stay inside of the device. In addition, the radiating plate 282 functions as a substrate for facilitating attachment of the LED substrates 281 to the chassis plate 22.

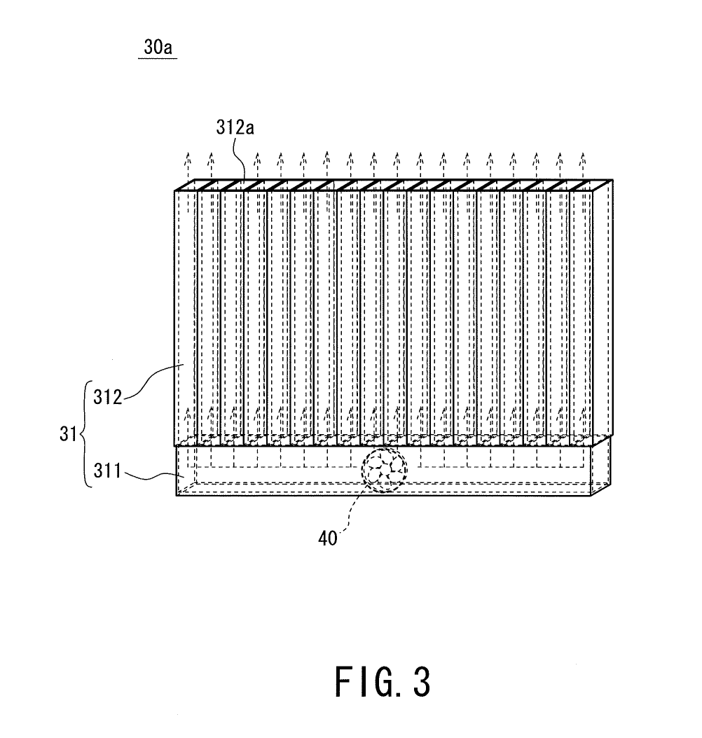

The cooling device 30a is attached to the back surface of the chassis plate 22. FIG. 3 is a schematic view showing the cooling device 30a. The cooling device 30a includes a through flow path (cooling pipe) 31 through which the air that defines a cooling medium runs, and a fan (air blower) 40 that is disposed in the through flow path 31.

The through flow path 31 includes a main duct 311 and branch ducts 312, and is made preferably from a material that has excellent thermal conductivity. Specific examples thereof include copper (a copper alloy) and aluminum (an aluminum alloy). It is more preferable to use copper (a copper alloy) that has high thermal conductivity in view of improving a cooling effect of the LED light sources 28. It is more preferable to use aluminum (an aluminum alloy) in view of workability, weight (weight reduction of the device) and costs in addition to thermal conductivity.

The main duct 311 has the shape of a thin box, and is disposed in a lateral direction along one side (lower end) of the liquid crystal display panel 10 as shown in FIGS. 1 to 3. An upper portion of the main duct 311 is open, and the plurality of branch ducts 312 are attached so as to cover the opening. The fan 40 is disposed at the center of the main duct 311 (a base portion of the main duct 311). An air inlet (not shown) is provided behind the fan 40. When the fan 40 rotates, cooling air is introduced from the air inlet into the main duct 311.

Each of the branch ducts 312 has a rectangular shape in cross section, and extends in a direction perpendicular to the main duct 311 (extends in a longitudinal direction). Base ends (one ends) of the branch ducts 312 are connected to the open upper portion of the main duct 311 as described above. The plurality of branch ducts 312 (eighteen branch ducts in the present embodiment) cover the entire opening of the main duct 311. The branch ducts 312 are brazed to the main duct 311, leaving no space therebetween. The adjacent branch ducts 312 are connected to one another.

Ends (top ends) of the branch ducts 312, the ends being opposite to the ends connected to the main duct 311, open upward (include exhaust ports 312a) as shown in FIG. 3. The branch ducts 312 are same in length, so that the top ends of the branch ducts 312 are positioned on a same plane.

Having the configuration described above of including the main duct 311 and the branch ducts 312, each of which has the outer shape of a rectangular column, the through flow path 31 forms one flat plate as shown in FIG. 3 when the main duct 311 and the branch ducts 312 are connected. The flat plate is same or larger in size than a bottom surface of the chassis plate 22. It is preferable that the cooling device 30a including the fan 40 inside of the flat-plate-shaped through flow path 31 is fixed to the bottom surface of the chassis plate 22 with glue. Alternatively, it is preferable that the cooling device 30a is made form a material that has high thermal conductivity, and is fixed to the bottom surface of the chassis plate 22 while sandwiching therebetween an adhesive sheet 41 having adhesive faces on both sides.

Next, a description of the operation of the liquid crystal display device 1 having the configuration described above will be provided. Image signals such as television broadcasting signals are subjected to image processing by an image-signal processing unit provided to the control board 162. The signals subjected to image processing are outputted to a liquid-crystal-display-panel control unit and a backlight control unit. The liquid-crystal-display-panel control unit controls the liquid crystal display panel 10 (TFTs) based on the received image signals. The backlight control unit controls the LED light sources 28 to light up, and controls the fan 40 of the cooling device 30a to be driven. The lighting of the LED light sources 28 and the driving of the fan 40 do not have to be performed simultaneously. It is also preferable to control the fan 40 to be driven after a lapse of time after the LED light sources 28 go out, the time being obtained in advance by measuring a time that is needed to cool the LED light sources 28 after the lighting of the LED light sources 28.

When the fan 40 is driven, the cooling air is introduced into the main duct 311. The cooling air introduced into the main duct 311 is sent into the branch ducts 312 that branch off from the main duct 311. The cooling air that runs through the branch ducts 312 flows upward while removing the heat generated by the LED light sources 28 that make up the “direct” backlight and are disposed in a planar fashion on the inner bottom surface of the chassis plate 22. Because the ends of the branch ducts 312 are open, the air heated by the heat generated by the LED light sources 28 is discharged to the outside of the device from the openings (exhaust ports 312a).

Thus, in the liquid crystal display device 1 of the present embodiment, the air, which is cooled by the cooling air introduced from the main duct 311 and used to cool the LED light sources 28, is discharged to the outside of the device from the exhaust ports 312a of the branch ducts 312. In other words, the cooling air that has risen in temperature can be discharged to the outside of the device to introduce new cooling air (low in temperature) in turn into the main duct 311. Thus, it is unnecessary to provide a cooling-medium cooling mechanism such as a cooler arranged to cool the cooling air that has risen in temperature.

Further, because the main duct 311 lies in the lower part of the device, and the branch ducts 312 the ends of which are open are disposed so as to extend in the longitudinal direction from the main duct 311 (disposed so that the cooling air flows upward), the cooling air that is heated by the LED light sources 28 becomes lighter in weight to go up, which allows the heated air to be smoothly discharged to the outside of the device.

Next, detailed descriptions of other preferred embodiments of the present invention will be provided. The display devices of the other preferred embodiments are different from the display device of the first embodiment only in the configuration of a cooling device unless described specifically. Thus, the cooling devices, which are different from that of the display device of the first embodiment, are mainly described, and explanations of other components of the display devices of the other preferred embodiments, which are common to the corresponding other components of the display device of the first embodiment, are omitted, providing reference numerals same as the corresponding other components of the display device of the first embodiment.

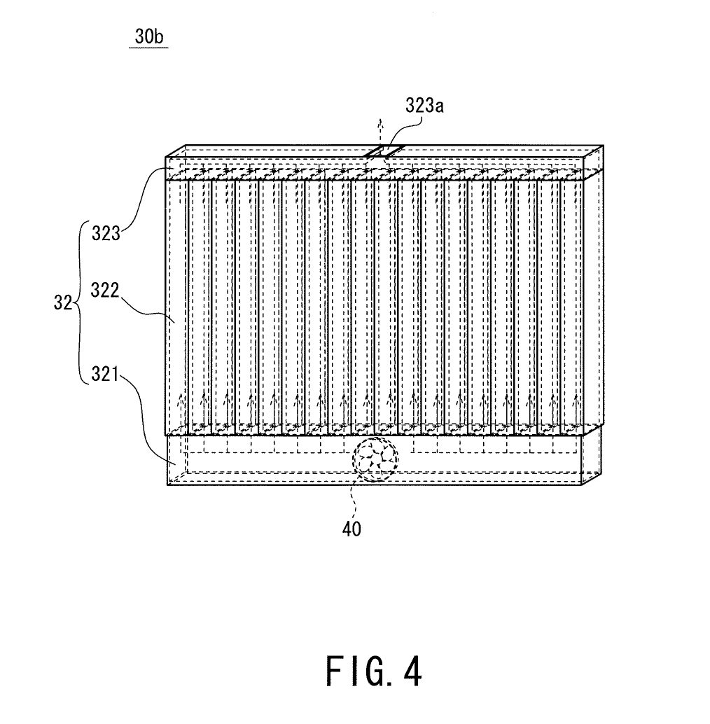

A liquid crystal display device (an LED backlight unit) of a second embodiment of the present invention will be described. FIG. 4 is a schematic view showing a cooling device 30b of the liquid crystal display device of the second embodiment. The cooling device 30b is different from the cooling device 30a of the first embodiment in including an exhaust duct (second branch duct) 323 arranged to discharge the cooling air.

To be specific, the cooling device 30b includes a through flow path 32 and the fan 40. The through flow path 32 includes a main duct 321, (first) branch ducts 322, and an exhaust duct (second branch duct) 323. The fan 40 arranged to introduce the air is disposed at the center of the main duct 321. Top ends of the branch ducts 322 that branch off upward from the main duct 321 are open, and all connected to the exhaust duct 323, leaving no space therebetween. To be specific, the exhaust duct 323 has the shape of a box symmetrical in the up/down direction to the main duct 321. That is, a lower portion of the exhaust duct 323 is open. The top ends of the first branch ducts 322 are connected to the opening of the exhaust duct 323, leaving no space therebetween. The exhaust duct 323 includes an exhaust port 323a that is open upward and disposed at the center on an upper surface of the exhaust duct 323.

The operation of the cooling device 30b having the above-described configuration will be described. When the fan 40 is driven, the cooling air is introduced into the main duct 321. The cooling air introduced into the main duct 321 is sent into the first branch ducts 322 that branch off from the main duct 321. The cooling air that runs through the first branch ducts 322 flows upward while removing the heat generated by the LED light sources 28 that make up the “direct” backlight and are disposed in a planar fashion on the inner bottom surface of the chassis plate 22.

Then, the air used for cooling the LED light sources 28, that is, the cooling air that runs up to the top ends of the first branch ducts 322, is sent into the exhaust duct 323 connected to the first branch ducts 322. The cooling air sent into the exhaust duct 323 is discharged to the outside of the device from the exhaust port 323a disposed at the center on the upper surface of the exhaust duct 323.

In the liquid crystal display device of the second embodiment, the cooling air that has risen in temperature can be discharged to the outside of the device from the exhaust port 323a of the exhaust duct 323 to introduce new cooling air (low in temperature) in turn into the main duct 321. Thus, it is unnecessary to provide a cooling-medium cooling mechanism such as a cooler arranged to cool the cooling air that has risen in temperature.

Further, the exhaust duct 323 connected to the top ends of the first branch ducts 322 is provided, and the exhaust port 323a is provided to the exhaust duct 323 in the present embodiment. To be specific, the display device of the present embodiment has the configuration that the air that runs through the first branch ducts 322 and used for cooling is collected at the exhaust duct 323 and discharged from the exhaust port 323a. Thus, the area of the exhaust of the discharged air can be decreased. In addition, changing the position of the exhaust port 323a allows free setting of the discharge position of the air.

The size of the exhaust port 323a is changeable appropriately. There is an advantage that the area of the exhaust of the discharged air is decreased as the size of the exhaust port 323a is smaller. However, if the exhaust port 323a is too small in size, the air used for cooling could not be smoothly discharged therefrom to the outside of the device, which could decrease the cooling effect. In order to solve this problem, it is preferable to set the size of the exhaust port 323a by calculating a cooling effect required of the cooling device 30b based on standards of the LED light sources 28 to be used.

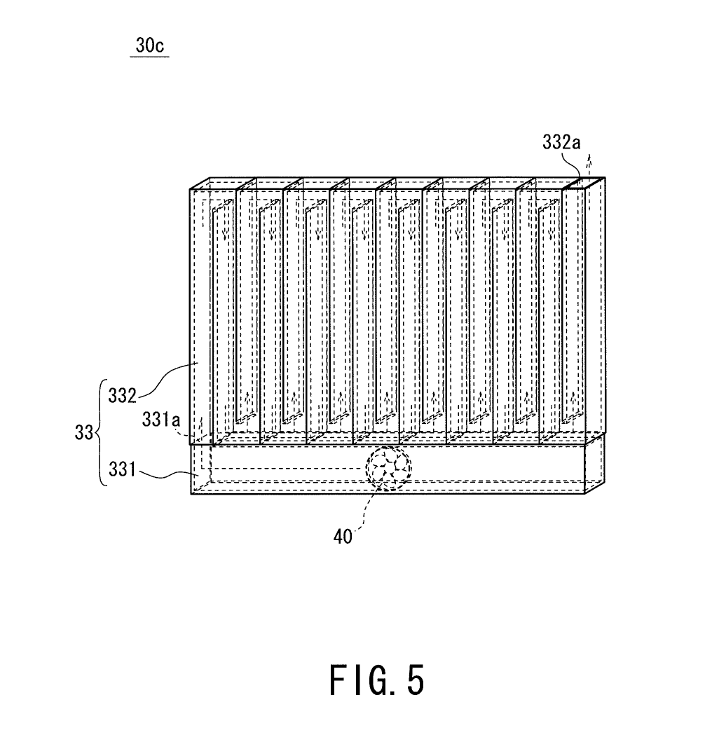

A liquid crystal display device (an LED backlight unit) of a third embodiment of the present invention will be described. FIG. 5 is a schematic view showing a cooling device 30c of the liquid crystal display device of the third embodiment.

The cooling device 30c includes a through flow path 33 and the fan 40. The through flow path 33 includes a main duct 331 and a branch duct 332 that are arranged to introduce the cooling air.

The main duct 331 has a rectangular shape in cross section. An upper surface of the main duct 331 is not totally open, which is a different configuration from the first embodiment. An opening 331a that is same in size as a base end (one end) of the branch duct 332 is provided at one end on the upper surface of the main duct 331. The branch duct 332 has a rectangular shape in cross section and a winding shape such that the branch duct 332 runs in a zigzag in the up/down direction. The base end (one end) of the branch duct 332 is connected to the opening 331a of the main duct 331, leaving no space therebetween. Meanwhile, an exhaust port 332a that is open upward is provided at a top end (the other end) of the branch duct 332.

The operation of the cooling device 30c having the above-described configuration will be described. When the fan 40 is driven, the cooling air is introduced into the main duct 331. The cooling air introduced into the main duct 331 is sent into the branch duct 332 through the opening 331a of the main duct 331. The cooling air that runs through the branch duct 332 flows in a zigzag in the up/down direction while removing the heat generated by the LED light sources 28 that make up the “direct” backlight and are disposed in a planar fashion on the inner bottom surface of the chassis plate 22. Then, the air used for cooling the LED light sources 28 is discharged to the outside of the device from the exhaust port 332a disposed at the top end of the branch duct 332.

In the liquid crystal display device of the third embodiment, the cooling air that has risen in temperature can be discharged to the outside of the device from the exhaust port 332a of the branch duct 332 to introduce new cooling air (low in temperature) in turn into the main duct 331. Thus, it is unnecessary to provide a cooling-medium cooling mechanism such as a cooler arranged to cool the cooling air that has risen in temperature.

Further, in the present embodiment, the branch duct 332 is winding so as to run in a zigzag in the up/down direction and thus has a flat plate shape in order to cool the “direct” backlight that is made up of the LED light sources 28 disposed in a planar fashion. This configuration allows the area of the exhaust of the discharged air to be decreased, and allows the air heated by the LED light sources 28 to be smoothly discharged to the outside of the device.

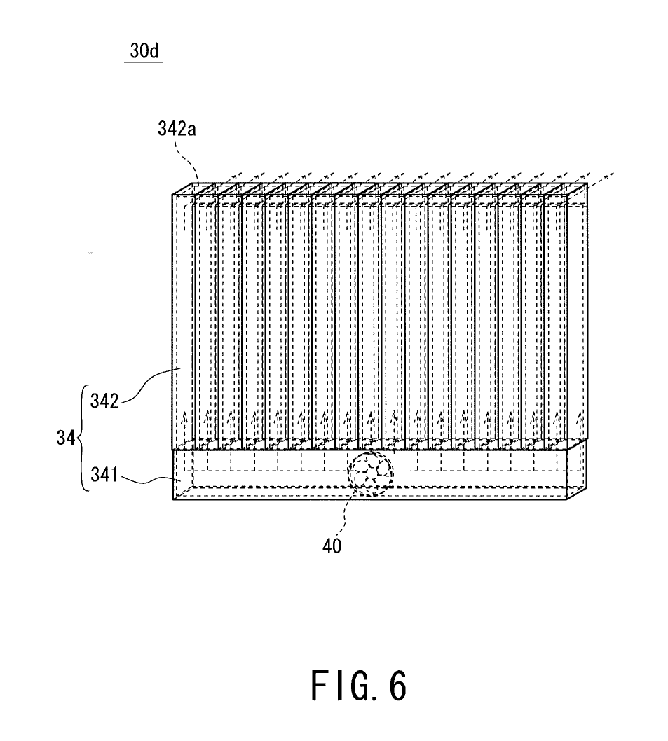

A liquid crystal display device (an LED backlight unit) of a fourth embodiment of the present invention will be described. FIG. 6 is a schematic view showing a cooling device 30d of the liquid crystal display device of the fourth embodiment. The cooling device 30d includes exhaust ports 342a provided to branch ducts 342, which is a different configuration from the first embodiment.

To be specific, the cooling device 30d includes a through flow path 34 and the fan 40. The through flow path 34 includes a main duct 341 and the branch ducts 342. The fan 40 arranged to introduce the air is disposed at the center of the main duct 341. The exhaust ports 342a that are open upward in a direction perpendicular to a longitudinal direction of the branch ducts 342 are provided at top ends of the branch ducts 342 that branch off upward from the main duct 341. To be specific, the exhaust ports 342a are provided on a back surface of the liquid crystal display device, and open in a direction perpendicular to the back surface.

The operation of the cooling device 30d having the above-described configuration will be described. When the fan 40 is driven, the cooling air is introduced into the main duct 341. The cooling air introduced into the main duct 341 is sent into the branch ducts 342 that branch off from the main duct 341. The cooling air that runs through the branch ducts 342 flows upward while removing the heat generated by the LED light sources 28 that make up the “direct” backlight and are disposed in a planar fashion on the inner bottom surface of the chassis plate 22. Then, the air that runs up to the top ends of the branch ducts 342 is discharged to the outside of the device from the exhaust ports 342a disposed on the back surface of the liquid crystal display device.

In the liquid crystal display device of the fourth embodiment, the cooling air that has risen in temperature can be discharged to the outside of the device from the exhaust ports 342a of the branch duct 342 to introduce new cooling air (low in temperature) in turn into the main duct 341. Thus, it is unnecessary to provide a cooling-medium cooling mechanism such as a cooler arranged to cool the cooling air that has risen in temperature.

Further, the liquid crystal display device has the configuration that the exhaust ports 342a provided at the top ends of the branch ducts 342 are disposed on the back surface of the liquid crystal display device in the present embodiment. Because the liquid crystal display device is usually installed such that its back surface is opposed to a wall, the configuration that the air used for cooling the LED light sources 28 is discharged toward the wall improves the usability of the liquid crystal display device (produces a less adverse effect caused by the discharge air) . In addition, the configuration that the exhaust ports 342a open in the direction perpendicular to the back surface prevents the entry of dirt from the exhaust ports 342a.

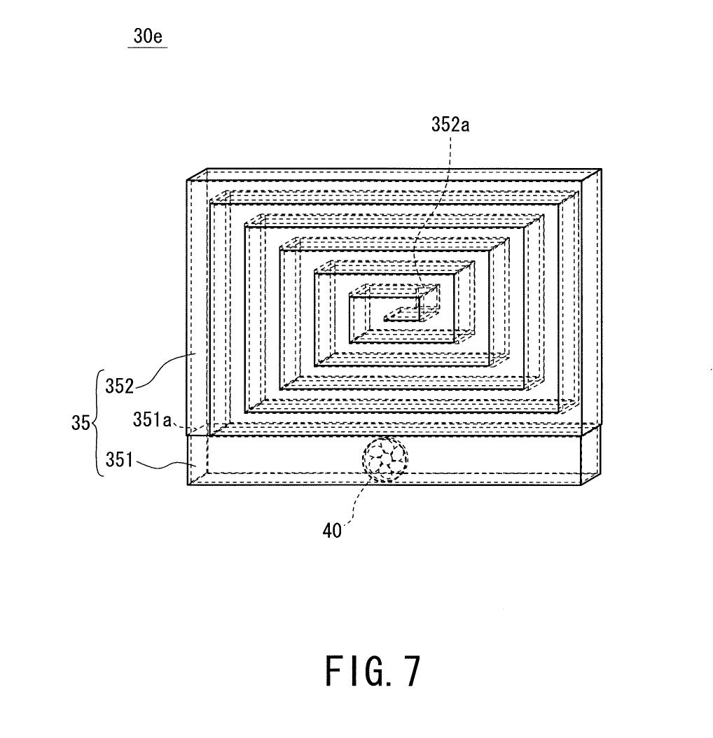

A liquid crystal display device (an LED backlight unit) of a fifth embodiment of the present invention will be described. FIG. 7 is a schematic view showing a cooling device 30e of the liquid crystal display device of the fifth embodiment.

The cooling device 30e includes a through flow path 35 and the fan 40. The through flow path 35 includes a main duct 351 and a branch duct 352.

The main duct 351 has a rectangular shape in cross section. An upper surface of the main duct 351 is not totally open, which is a different configuration from the first embodiment. An opening 351a that is same in size as a base end (one end) of the branch duct 352 is provided at one end on the upper surface of the main duct 351, which is a similar configuration to the third embodiment. The branch duct 352 has a rectangular shape in cross section, and a winding shape such that the branch duct 352 runs in a spiral fashion from the outside. The base end (one end) of the branch duct 352 is connected to the opening 351a of the main duct 351, leaving no space therebetween. Meanwhile, an exhaust port 352a is provided at the center on a back surface of the liquid crystal display device, and opens in a direction perpendicular to the back surface.

The operation of the cooling device 30e having the above-described configuration will be described. When the fan 40 is driven, the cooling air is introduced into the main duct 351. The cooling air introduced into the main duct 351 is sent into the branch duct 352 through the opening 351a. The cooling air that runs through the branch duct 352 flows inward in the spiral fashion while removing the heat generated by the LED light sources 28 that make up the “direct” backlight and are disposed in a planar fashion on the inner bottom surface of the chassis plate 22. Then, the air that runs up to the top end of the branch duct 352 is discharged to the outside of the device from the exhaust port 352a disposed at the center on the back surface of the liquid crystal display device.

In the liquid crystal display device of the fifth embodiment, the cooling air that has risen in temperature can be discharged to the outside of the device from the exhaust port 352a of the branch duct 352 to introduce new cooling air (low in temperature) in turn into the main duct 351. Thus, it is unnecessary to provide a cooling-medium cooling mechanism such as a cooler arranged to cool the cooling air that has risen in temperature.

Further, the liquid crystal display device has the configuration that the exhaust port 352a provided at the top end of the branch duct 352 is disposed at the center on the back surface of the liquid crystal display device in the present embodiment. Because the liquid crystal display device is usually installed such that its back surface is opposed to a wall, the configuration that the air used for cooling the LED light sources 28 is discharged toward the wall improves the usability of the liquid crystal display device (produces few adverse effect caused by the discharge air). In addition, the configuration that the exhaust port 352a opens from the center of the panel in the direction perpendicular to thereto prevents the entry of dirt from the exhaust port 352a.

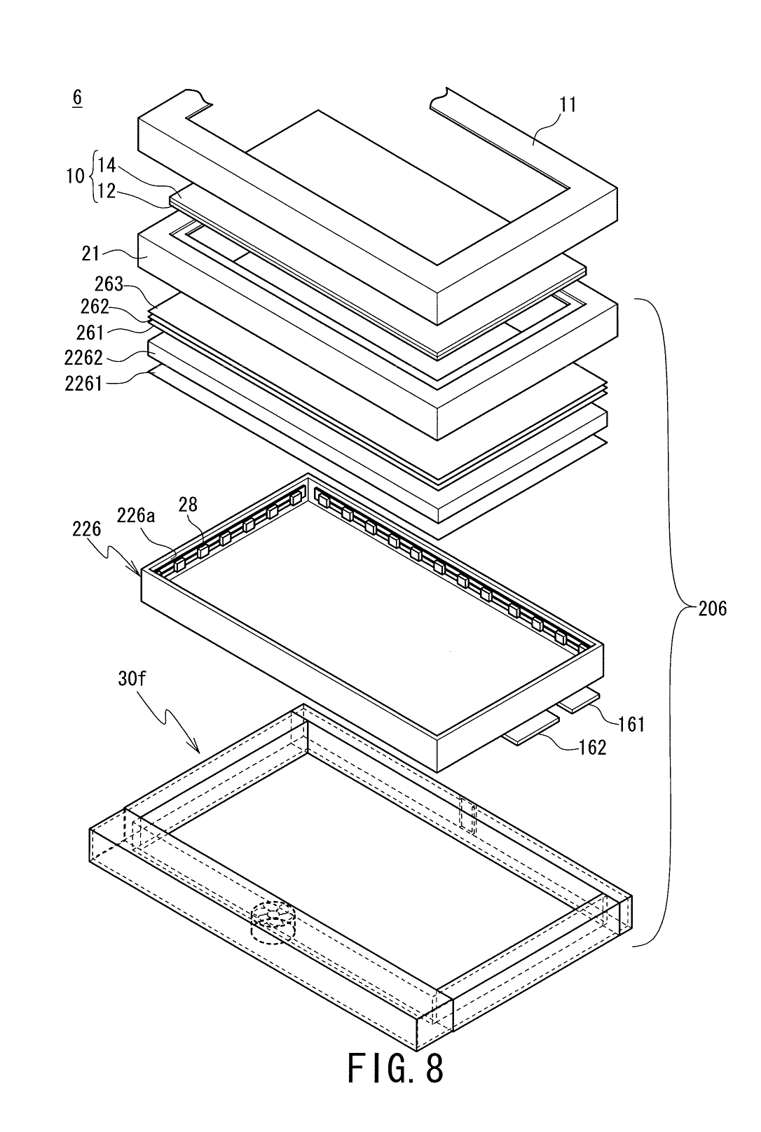

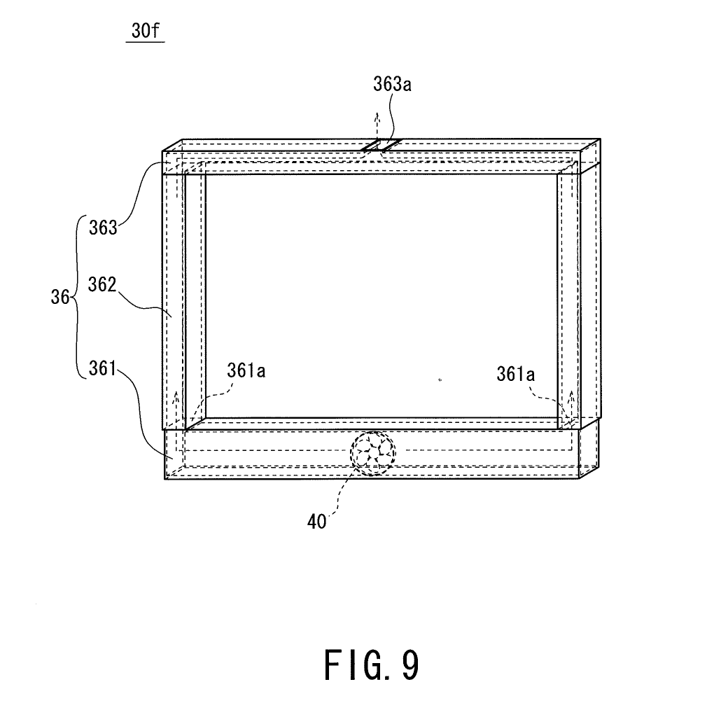

A liquid crystal display device 6 (an LED backlight unit 206) of a sixth embodiment of the present invention will be described. FIG. 8 is an exploded perspective view showing the liquid crystal display device 6 of the sixth embodiment of the present invention. FIG. 9 is a schematic view showing a cooling device 30f of the liquid crystal display device 6 shown in FIG. 8.

The liquid crystal display device 6 of the present embodiment includes the LED backlight unit 206 that defines a so-called “side” (edge-light) LED backlight unit having a configuration such that the LED light sources 28 are disposed on inner side surfaces 226a (four sides) of a chassis plate 226. In the present embodiment, the LED light sources 28 are disposed on each of the inner side surfaces 226a of the chassis plate 226 that has a rectangular sheet shape when seen in a plan view.

A reflection sheet 2261 arranged to efficiently reflect the light emitted from the LED light sources 28 (the light emitted from the lateral sides) toward the liquid crystal display panel 10, a light guide plate 2262 arranged to planarly diffuse the light reflected by the reflection sheet 2261, and the optical sheets 261, 262 and 263 (diffusion sheet 261, the lens sheet 262, and the reflection sheet 263) are disposed in the chassis plate 226.

The cooling device 30f includes a through flow path 36 and the fan 40. The through flow path 36 includes a main duct 361, first branch ducts 362 and a second branch duct 363.

The main duct 361 has a rectangular shape in cross section. An upper surface of the main duct 361 is not totally open, which is a different configuration from the first embodiment. Openings 361a that are same in size as base ends (one ends) of the first branch ducts 362 are provided at both ends on the upper surface of the main duct 361. Each of the first branch ducts 362 has a rectangular shape in cross section. The base ends (one ends) of the branch ducts 362 are connected to the openings 361a of the main duct 361, leaving no space therebetween. Meanwhile, the top ends (the other ends) of the first branch ducts 362 are connected to the second branch duct 363 that is disposed parallel to the main duct 361. That is, the through flow path 36 makes up a circle flow path from the main duct 361, the first branch ducts 362 and the second branch duct 363. The circle flow path has a shape and a size so as to be along the LED light sources 28 that are disposed on the inner side surfaces 226a (four sides) of the chassis plate 226. To be specific, the circle flow path has a shape and a size such that the through flow path 36 is in contact with surfaces of the chassis plate 226 opposite to the inner side surfaces 226a. An exhaust port 363a is provided at the center on an upper surface of the second branch duct 363.

The operation of the cooling device 30f having the above-described configuration will be described. When the fan 40 is driven, the cooling air is introduced into the main duct 361. The cooling air introduced into the main duct 361 is sent into the first branch ducts 362 and the second branch duct 363 through the openings 361a of the main duct 361. Because the main duct 361, the first branch ducts 362 and the second branch duct 363 are disposed along the LED light sources 28 that make up the “side” backlight and are disposed on the inner side surfaces 226a (four sides) of the chassis plate 226, the cooling air introduced into the through flow path 36 runs through the circle flow path while removing the heat generated by the LED light sources 28. Then, the air that runs to the center of the second branch duct 363 is discharged to the outside of the device from the exhaust port 363a.

The liquid crystal display device 6 of the sixth embodiment has the configuration that the through flow path 36 is disposed along the directions that the LED light sources 28 are disposed on the inner side surfaces 226a of the chassis plate 226, whereby the LED light sources 28 disposed in the “side” backlight can be cooled efficiently. In addition, the cooling air that has risen in temperature can be discharged to the outside of the device from the exhaust port 363a of the second branch duct 363 to introduce new cooling air (low in temperature) in turn into the main duct 361. Thus, it is unnecessary to provide a cooling-medium cooling mechanism such as a cooler arranged to cool the cooling air that has risen in temperature.

It is to be noted that the LED backlight unit 206 of the present embodiment has the configuration that the LED light sources 28 are disposed on all of the inner side surfaces 226a (four sides) of the chassis plate 226; however, the present invention is not limited to the configuration. For example, the LED backlight unit 206 of the present embodiment may have a configuration such that the LED light sources 28 are disposed on only one of the inner side surfaces 226a of the chassis plate 226. In this case, the through flow path 36 need not make up the circle flow path shown in FIG. 9. It is essential only that the through flow path 36 should be disposed along the position where the light sources 28 are disposed.

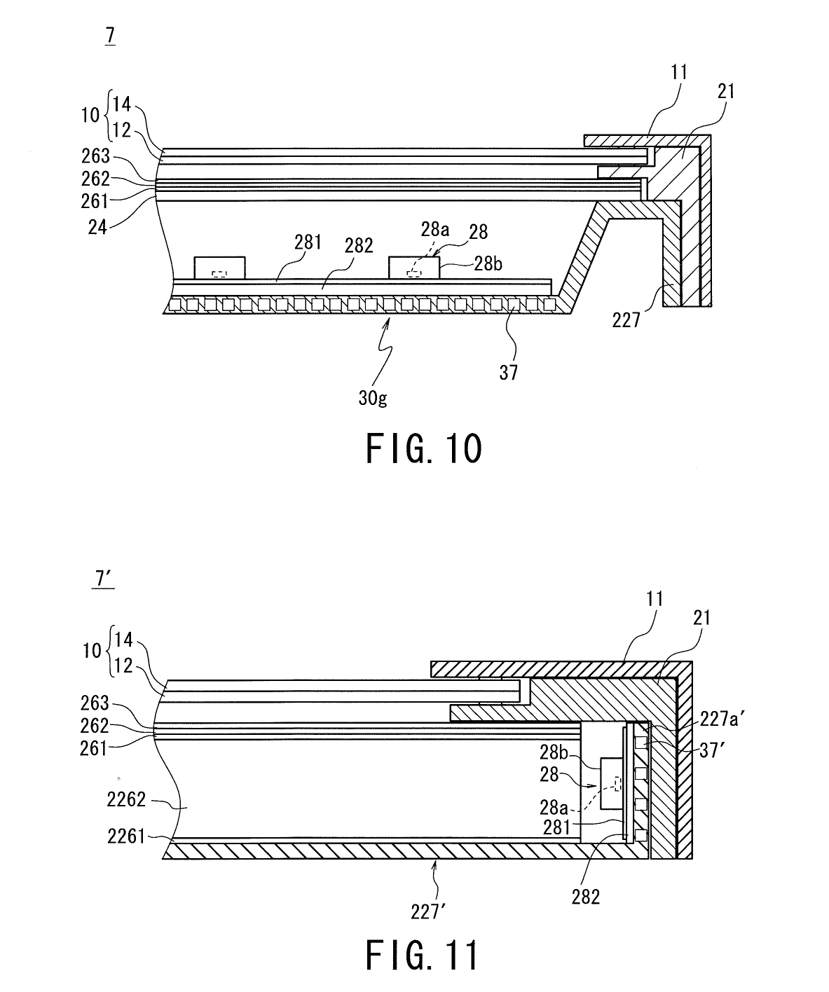

A liquid crystal display device 7 (an LED backlight unit) of a seventh embodiment of the present invention will be described. FIG. 10 is a cross-sectional view showing the liquid crystal display device of the seventh embodiment.

The liquid crystal display device of the present embodiment includes a cooing device 30g. The cooing device 30g includes a through flow path 37 and a fan (not shown) . In the present embodiment, the through flow path 37 are formed in a chassis plate 227. To be specific, the cooing device 30g of the present embodiment has the configuration that the through flow path 37 and the chassis plate 227 are of monolithic construction, while the cooling devices of the above-described embodiments have the configurations that the through flow paths 31 to 36 (cooling pipes) are fixed to the bottom surfaces of the chassis plates 22 (226).

Shown in FIG. 10 is the configuration that the flow path same as the through flow path 31 of the first embodiment is formed in the chassis plate 227. It is also preferable that the flow path same as the through flow paths of the other embodiments (second to sixth embodiments) is formed in the chassis plate 227. For example, in the case of using a so-called side backlight as used in the sixth embodiment, a through flow path 37′ may be provided on a side surface 227a′ of the chassis plate 227′ where the LED light sources 28 are disposed as shown FIG. 11 (a liquid crystal display device 7′).

In the liquid crystal display device 7 of the seventh embodiment, the cooling air that has risen in temperature can be discharged to the outside to introduce new cooling air (low in temperature) in turn into the through flow path 37. Thus, it is unnecessary to provide a cooling-medium cooling mechanism such as a cooler arranged to cool the cooling air that has risen in temperature. It is preferable that the chassis plate 227 is made from copper or a copper alloy in order to improve a cooling effect.

Further, the configuration of the present embodiment that the through flow path 37 and the chassis plate 227 are of monolithic construction can improve the cooling effect because the cooling air runs closer to the LED light sources 28. In addition, it is unnecessary to separately produce a through flow path through which the cooing air runs, which can reduce a material cost.

In the first to seventh embodiments described above, each of the through flow paths 31 to 37 of the cooling devices 30a to 30g has a rectangular shape in cross section. When the plurality of aligned branch ducts are used, which make up a flat plate, as in the first to fourth embodiments, the configuration of the rectangular shape can prevent the flat plate from increasing in thickness while allowing a flow rate of the cooling air that runs through the branch ducts to be increased (allowing a large cross-sectional area to be obtained).

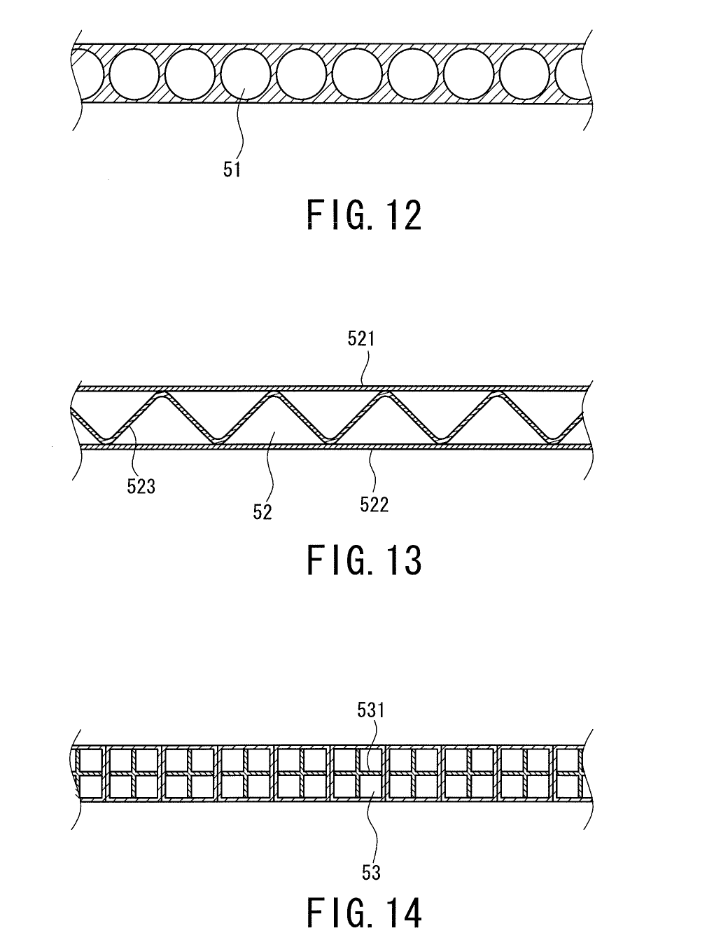

Meanwhile, the configurations shown in FIGS. 12 to 14 show modified examples of the cross-sectional shape. FIGS. 12 to 14 are schematic cross-sectional views showing flow paths, taking the through flow paths 31 to 37 of the first to fourth embodiments (having the configuration that the plurality of the branch ducts are aligned) as examples.

FIG. 12 is a view showing flow passages 51 of a first modified example. Each flow passage 51 has a round shape in cross section. When the plurality of aligned branch ducts are disposed side by side as in the first to fourth embodiments, the flow passages can be formed by boring holes in a flat plate having a given thickness, so that the flow passages 51, each of which has the round shape in cross section, can be easily formed.

FIG. 13 is a view showing flow passages 52 of a second modified example. Each flow passage 52 has a triangular shape in cross section, and the flow passages 52 face and fit each other (the oblique sides of the adjacent triangles fit each other). When the plurality of aligned branch ducts are disposed side by side as in the first to fourth embodiments, the flow passages can be formed by sandwiching a corrugated plate 523 between thin flat plates 521 and 522, so that the flow passages 52 can be easily formed. In addition, the configuration of the triangular shape can prevent the flat plate made up of the branch ducts from increasing in thickness while allowing a flow rate of the cooling air that runs through the branch ducts to be increased (allowing a large cross-sectional area to be obtained).

Next, a description of a modified example of the flow passages, which are modified in a respect other than the shape in cross section. FIG. 14 is view showing flow passages 53 of a third modified example. The flow passages 53 each include dividers 531 arranged to divide flow passages along a direction the cooling air flows. To be specific, the dividers 531 are disposed along the direction the cooling air flows so as to divide the cross-sectional surfaces of the flow passages 53. Each divider 531 shown in FIG. 14 has the shape of a cross in cross section. The shape of the dividers 531 is not limited specifically if the cross-sectional surfaces of the flow passages 53 are divided. In addition, the shape in cross section of the flow passages 53 is not limited specifically (it may be a round shape as in the first embodiment, or may be a triangular shape as in the second embodiment). The dividers 531 are made preferably from a material that has excellent thermal conductivity similarly to the flow passages 53. Examples of the material include copper (a copper alloy) and aluminum (an aluminum alloy). This configuration can increase the surface area inside the flow passages through which the cooling air runs, which can improve the cooling effect of the LED light sources 28 by the cooling air.

Shown in FIGS. 12 to 14 are the shapes in cross section of the modified examples of the branch ducts of the first to fourth embodiments. These shapes in cross section can be applied also to the shapes in cross section of the through flow paths 31 to 37, and 37° including the main ducts and branch ducts of the first to seventh embodiments.

The liquid crystal display devices (the LED backlight units) of the above-described embodiments of the present invention have the configurations that the cooling air that is used for cooling the LED light sources 28, i.e. the cooling air that has risen in temperature, can be discharged to the outside of the device to introduce new cooling air (low in temperature) in turn into the through flow path. Thus, it is unnecessary to provide a cooling-medium cooling mechanism such as a cooler arranged to cool the cooling air that has risen in temperature. In addition, the liquid crystal display devices (the LED backlight units) of the above-described embodiments of the present invention, which use air as a cooling medium, are free from a problem of a breakdown of the device due to leakage of a cooling medium. Thus, the present invention can provide a liquid crystal display device (an LED backlight unit) that has a simple configuration, and is of low maintenance and of high quality.

The foregoing description of the preferred embodiments of the present invention has been presented for purposes of illustration and description with reference to the drawings. However, it is not intended to limit the present invention to the embodiments, and modifications and variations are possible as long as they do not deviate from the principles of the present invention.

For example, described above in the preferred embodiments are the liquid crystal display devices; however, the technical ideas of the present invention are not limited thereto, and can be applied to a variety of devices including LED light sources.

1. A liquid crystal display device, the device comprising:
a liquid crystal display panel; and
an LED backlight unit disposed behind the liquid crystal display panel, the backlight unit comprising:
an LED light source arranged to emit LED light toward the liquid crystal display panel; and
a chassis plate on which the LED light source is disposed, the chassis plate comprising
a through flow path for cooling air that is arranged to dissipate heat generated by the emission of light from the LED light source,
wherein the through flow path comprises:
a main duct arranged to introduce the cooling air, the main duct being disposed along one side of the liquid crystal display panel; and
a branch duct that branches off from the main duct, is aligned along a disposed direction of the LED light source, and comprises an exhaust port that is disposed at an end of the branch duct and arranged to discharge the cooling air to outside of the device.

2. The liquid crystal display device according to claim 1, wherein the LED light source is disposed over an entire surface of the chassis plate, the surface being opposed to the liquid crystal display panel, and wherein the branch duct comprises a plurality of branch ducts that are aligned along the disposed direction of the LED light source on a back surface of the chassis plate.

3. The liquid crystal display device according to claim 1, wherein the LED light source comprises a plurality of LED light sources that are disposed on inner surfaces of the chassis plate, the inner surfaces being opposed to each other, and wherein the main duct and the branch duct are aligned along disposed directions of the LED light sources on a back surface of the chassis plate.

4. The liquid crystal display device according to claim 2, wherein the plurality of branch ducts comprise flow passages, each of which has a rectangular shape in cross section.

5. The liquid crystal display device according to claim 2, wherein the plurality of branch ducts comprise flow passages, each of which has a round shape in cross section.

6. The liquid crystal display device according to claim 2, wherein the plurality of branch ducts comprise flow passages, each of which has a triangular shape in cross section, and the flow passages face and fit each other.

7. The liquid crystal display device according to claim 1,
wherein the liquid crystal display panel stands,
wherein the main duct of the through flow path is disposed in a lateral direction along a lower end of the chassis plate, and
wherein the branch duct is disposed in a longitudinal direction along the chassis plate, whereby the cooling air flows upward.

8. The liquid crystal display device according to claim 1, wherein the exhaust port disposed at the end of the branch duct is open toward a back surface of the device.

9-14. (canceled)

15. An LED backlight unit that is used behind a display screen such as a liquid crystal display panel, the backlight unit comprising:
an LED light source arranged to emit LED light toward the liquid crystal display panel; and
a chassis plate on which the LED light source is disposed, the chassis plate comprising
a through flow path for cooling air that is arranged to dissipate heat generated by
the emission of light from the LED light source,
wherein the through flow path comprises:
a main duct arranged to introduce the cooling air, the main duct being disposed along one side of the liquid crystal display panel; and
a branch duct that branches off from the main duct, is aligned along a disposed direction of the LED light source, and comprises an exhaust port that is disposed at an end of the branch duct and arranged to discharge the cooling air to outside.

16. The LED backlight unit according to claim 15, wherein the LED light source is disposed over an entire surface of the chassis plate, the surface being opposed to the liquid crystal display panel, and wherein the branch duct comprises a plurality of branch ducts that are aligned along the disposed direction of the LED light source on a back surface of the chassis plate.

17. The LED backlight unit according to claim 15, wherein the LED light source comprises a plurality of LED light sources that are disposed on inner surfaces of the chassis plate, the inner surfaces being opposed to each other, and wherein the main duct and the branch duct are aligned along disposed directions of the LED light sources on a back surface of the chassis plate.

18. The LED backlight unit according to claim 16, wherein the plurality of branch ducts comprise flow passages, each of which has a rectangular shape in cross section.

19. The LED backlight unit according to claim 16, wherein the plurality of branch ducts comprise flow passages, each of which has a round shape in cross section.

20. The LED backlight unit according to claim 16, wherein the plurality of branch ducts comprise flow passages, each of which has a triangular shape in cross section, and the flow passages face and fit each other.

21. The LED backlight unit according to claim 15, wherein the through flow path and the chassis plate are of separate construction.

22. The LED backlight unit according to claim 15, wherein the through flow path and the chassis plate are of monolithic construction.

23. The LED backlight unit according to claim 15, wherein the through flow path is made from either one of copper and a copper alloy.

24. The LED backlight unit according to claim 15, wherein the through flow path is made from either one of aluminum and an aluminum alloy.

25. The LED backlight unit according to claim 15, wherein a base portion of the main duct is connected to an air blower that is arranged to force the air to be introduced into the main duct.

26. The LED backlight unit according to claim 15, wherein the through flow path further comprises a divider arranged to divide the through flow path along a direction that the cooling air flows.
